(19) United States
(12) Patent Application Publication
(10) Pub. No.: US 2004/0191608 A1
(43) Pub. Date: Sep. 30, 2004

(54) Post-molding treatment of current collector plates for fuel cell to improve conductivity

(76) Inventors: Divya Chopra, Kingston (CA); James Guolla, Kingston (CA); Yuqi Cai, Kingston (CA); Larin Godfroy, Napanee (CA); Peter Andrin, Kingston (CA); John Charles Fisher, Kingston (CA); Andrew Chi Yan Li, Pierrefonds (CA)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/603,364

(22) Filed: Jun. 23, 2003

(30) Foreign Application Priority Data
Mar. 27, 2003 (WO) PCT/CA03/00442

(51) Int. Cl. H01M 4/96; C08J 5/00

(52) U.S. Cl. 429/44; 264/331.11

(57) ABSTRACT

Disclosed is a method of making a current collector plate for use in a proton exchange membrane fuel cell. The method includes the steps of: (a) molding the current collector plate by injection, compression or any other molding process from a resin/conductive filler composition; (b) measuring the current collector plate's average thickness; (c) measuring the current collector plate's through-plane resistivity; (d) removing a portion of the current collector plate's surface layer by abrasion; and (e) repeating steps (a) to (d) until a desired plate thickness is removed. The desired plate thickness removed is no more than about 10 micrometers, and preferably about 5 micrometers.

### FIELD OF THE INVENTION

This invention relates to a process for making current collector plates for use in proton exchange membrane fuel cells, wherein the current collector plates have reduced through-plane resistivity.

### BACKGROUND OF THE INVENTION

With the fast rising global demand for cheap and clean power, the development of polymer electrolyte membrane fuel cells (PEMFC) has accelerated greatly. A typical single solid polymer electrolyte membrane fuel cell comprises an anode current collector plate, an anode backing layer, an anode catalyst layer, a membrane, a cathode catalyst layer, a cathode backing layer and a cathode current collector plate. Individual fuel cells may be connected in series to form a fuel cell stack.

Current collector plates, also called flow field plates or separator plates, perform the functions of connecting individual cells, collecting cell current generated within the cells, accommodating or distributing cell reactants, removing cell reaction products and assisting with thermal control. To meet these requirements, the collector plates must have excellent electrical conductivity, good mechanical strength, sufficient chemical stability and low gas permeability. As well, the materials used to make the plates, and their method of manufacture, must have a low cost to allow the plates to be commercially viable.

A typical collector plate also includes flow field channels on its surfaces to direct fuel reactants or oxygen, and reaction by-products such as water. Graphite plates with machined flow fields have historically been used as collector plates for fuel cells. Due to their brittleness and high fabrication/machining cost, graphite plates are relatively expensive to make such that they cannot meet the requirements for large-scale commercialization of fuel cells.

Recently, substantial efforts have been focused on making collector plates by injection or compression molding of thermoplastic conductive polymer compositions. These plates can have flow-field channels molded directly onto their surfaces without having to post-machine the flow fields.

Highly conductive polymer compositions for use in making current collector plates have been disclosed. For example, in U.S. Pat. No. 4,339,322 to Balks et al, there is disclosed a bipolar current collector plate for electrochemical cells comprising a moulded aggregate of graphite and a thermoplastic fluoropolymer particles reinforced with carbon fibres to increase strength and maintain high electrical conductivity. However, the polymer composite materials need to be developed so that they are compatible with both the fuel cell operating requirements and the high speed moulding process.

U.S. Pat. No. 4,098,967 to Biddick et al. provides a bipolar plate formed of thermoplastic resin filled with 40-80% by volume finely divided vitreous carbon. Plastics employed in the compositions include polyvinylidene fluoride and polyphenylene oxide. The plates are formed by compression moulding dry blended compositions and possess specific resistance on the order of 0.002 ohm-cm. Compression moulded bipolar plates from solution blends of graphite powder and polyvinylidene fluoride are disclosed in U.S. Pat. No. 3,801,374 to Dews et al. The plate so formed has a density of 2.0 g/cc and volume resistivity of 4×10⁻³ ohm-cm.

U.S. Pat. No. 4,214,969 to Lawrence discloses a bipolar plate fabricated by pressure moulding a dry mixture of carbon or graphite particles and a fluoropolymer resin. The carbon or graphite particles are present in a weight ratio to the polymer of between 1.5:1 and 16:1. The polymer concentration is in the range of 6-28% by weight and the volume resistivity of the plate is in the range of 1.2-3.5×10⁻³ ohm-in.

U.S. Pat. No. 4,554,063-85 to Braun et al. discloses a process for fabricating cathode current collectors. The current collector consists of graphite (synthetic) powder of high purity having particle sizes in the range from 10 micrometer to 200 micrometer and carbon fibers that are irregularly distributed therein and have lengths from 1 mm to 30 mm, the graphite powder/carbon fiber mass ratio being in the range from 10:1 to 30:1. The polymer resin used is polyvinylidene fluoride. For producing the current collector, the resin is dissolved in, for example, dimethylformamide. Graphite powder and carbon fibers are then added and the resulting lubricating grease-like mass is brought to the desired thickness by spreading on a glass plate and is dried for about 1 hour at about 50° C. The plates were also formed by casting, spreading, or extrusion.

U.S. Pat. No. 5,582,622 to Lafollette discloses bipolar plates comprising a composite of long carbon fibers, a filler of carbon particles and a fluoroelastomer.

Reference may also be made to PCT publication WO 00/44005 which discloses a shaped article having particular use as a conductive plate in a fuel cell having a volume resistivity of less than 10⁻² ohm-cm and being made from a composition comprising about 5 to about 50% by weight of nickel-coated graphite fibers of a length less than 2 cm, and about 0.1 to about 20% by weight of the graphite, of a non-liquid-crystalline thermoplastic binder resin.

There are a number of other patents that describe methods for manufacturing current collectors of particular formulations. Among these is U.S. Pat. No. 4,839,114 to Delphin et al., which includes 35-45% of carbon black fill, and optionally not more than 10% by weight carbon fibers as part of the fill. U.S. Pat. No. 5,942,347 to Koncar et al. describes a bipolar separator plate comprising at least one electronically conductive material in an amount of from about 50% to about 95% by weight of the separator plate, at least one resin in an amount at least about 5% by weight of the separator plate and the hydrophilic agent. The conductive material can be selected from carbonaceous materials including graphite, carbon black, carbon fibers and mixtures thereof.

In U.S. Pat. No. 6,180,275 to Braun et al. and in International Publications Nos. WO 00/30202 and WO 00/30203, there are described moulding compositions for providing current collector plates which include conductive fillers in various forms, including powder and fiber. High purity graphite powder is preferred having a carbon content of greater than 98%. The graphite powder preferably has an average particle size of approximately 23 to 26 micrometer micrometers and a BET-measured surface area of approximately 7-10 m²/g. The description indicates that fibers having a surface area of less than 10 m²/g coupled with a fiber length in excess of 250 micrometers are typical. Carbon fibers are specifically mentioned in the description. The preferred composition contains 45-95 weight percent graphite powder, 5-50 weight percent polymer resin and 0-20 weight percent metallic fiber, carbon fiber and/or carbon nanofiber.

U.S. Pat. No. 6,248,467 to Wilson et al., claims a bipolar plate moulded from a thermal setting vinyl ester resin matrix having a conductive powder embedded therein. The powder may be graphite having particle sizes predominantly in the range of 80-325 mesh. Reinforcement fibers selected from graphite/carbon, glass, cotton and polymer fibers are also described.

An example of a typical method for manufacturing shaped bodies formed from plastics-filler mixtures having a high filler content can be found in U.S. Pat. No. 5,804,116 granted to Schmid et al. In this method, which extrusion moulds a plastic-filler mixture containing more than 50% by volume of fillers, the first step involves uniformly distributing the filler in a molten plastic, then discharging the mixture and allowing it to harden. The hardened mixture is then broken up and ground and the ground mixture or fractions thereof are made uniform as to grain size and then extruded by means of an extruder with a conveying input zone to form moulded bodies.

Injection and compression molded current collector plates (particularly those containing thermoplastics) have electrically resistive, polymer-rich surface layers that affect the performance of fuel cells during operation. Since an electric current is conducted across an interface containing these surface layers, a portion of the electric current will be transformed into heat, thereby decreasing the overall electrical efficiency of the fuel cell. Thus, the conductivity of the molded current collector plate is restricted due to the higher concentrations of polymer resin at the exterior surface layers.

A preferred polymer composition for making fuel cell current collector plates is disclosed in co-pending PCT patent application no. PCT/CA03/00202 filed Feb. 13, 2003. The composition includes from about 10 to about 50% by weight of a plastic, from about 10 to about 70% by weight of a graphite fibre filler having fibres with a length of from about 15 to about 500 micrometers, and from 0 to about 80% by weight of a graphite powder filler having a particle size of from about 20 to about 1500 micrometers. Preferably, the plastic is selected from thermoplastic and thermosetting plastics and elastomers, and most preferably the plastic is a thermoplastically processable fluorine-containing polymer.

U.S. Pat. No. 6,451,471 to Braun discloses a method of manufacturing a PEMFC current collector plate. The method includes the steps of: providing a current collector plate having land areas on opposing surfaces of the plate, and then removing a layer of the composition from at least one of the land areas. After the layer removal, the new land areas have reduced concentrations of polymer. The layer removal is preferably performed using machining, sanding or surface grinding. The thickness of the layer to be removed must be sufficiently large to remove the areas of high polymer concentration. It may also be desirable to remove an even greater thickness to improve the molding process. The removed layer should be between 0.001 and 0.5 cm thick, and is preferably in the range of 0.015 and 0.06 cm thick. This layer removal is said to result in increased overall conductivity of the molded current collector plate.

The disclosures of all patents/applications referenced herein are incorporated herein by reference.

### SUMMARY OF THE INVENTION

It has now been found that removing a much smaller layer from the surfaces of the molded plates may significantly increase the conductivity of molded polymeric current collector plates. The present invention therefore relates generally to the post molding treatment of a conductive current collector plate used in a PEMFC. The present invention improves on the method disclosed in U.S. Pat. No. 6,451,471, in which it is disclosed that the removal of 0.001 to 0.5 cm of the plate surface results in a 38% drop in through plane resistivity. The present inventors have unexpectedly found that in certain circumstances, a similar or better drop in through plane resistivity can be achieved by removing less than 0.001 cm, preferably about 0.0005 cm, of the surface layer. By removing the resin rich layer at the surface of the current collector plate and exposing the conductive filler-rich layers underneath, the present inventors have found that the through-plane resistivity can be reduced by approximately 50%.

In accordance with one aspect of the present invention, there is provided a conductive fuel cell flow field plate with improved through plane conductivity.

In accordance with a second aspect of the present invention, there is provided a method of making a current collector plate for use in a proton exchange membrane fuel cell, the method comprising the steps of:

(a) molding by injection or compression molding a composition comprising from about 10 to about 50% by weight of a plastic, from about 10 to about 70% by weight of a graphite fibre filler, and from 0 to about 80% by weight of a graphite powder filler to form the current collector plate having two surface layers;

(b) measuring the thickness of the current collector plate; and

(c) removing the surface layers to reduce the thickness of the current collector plate by no more than about 10 micrometers.

In preferred embodiments, one or both of the surfaces of the current collector plates comprise flow field channels and lands defined by the channels, and the thickness is measured at the lands, and the thickness at the lands is reduced by no more than about 10 micrometers.

### BRIEF DESCRIPTION OF THE DRAWINGS

The preferred embodiments of the present invention will be described with reference to the accompanying drawings in which like numerals refer to the same parts in the several views and in which:

FIG. 1 is a plot showing the relationship between the contact resistivity values versus the amount of surface layer removed in a preferred embodiment of the present invention.

FIG. 2 is a plot showing the relationship between the percentage drop in contact resistivity versus the amount of surface layer removed in a preferred embodiment of the present invention.

### DETAILED DESCRIPTION OF THE PREFERRED EMBODIMENTS

The preferred embodiments of the present invention will now be described with reference to the accompanying figures.

In a preferred embodiment of the present invention, a method is provided for molding current collector plates that provide an improvement in through-plane resistivity by removing less than 10 μm of the top surface layer. By exposing the conductive filler-rich composition underneath the thin resin-rich top surface layer results in a drop of through-plane resistivity by as much as about 50%.

The method of the present invention provides a low cost, repeatable and rapid manufacturing process that is easily adapted for automation. In the preferred method, the steps include the following:

1. Molding a current collector plate by injection or compression molding from a resin/conductive filler composition. The current collector plate may optionally have flow field channels and lands defined by the channels on one or both of its surfaces.

2. Measuring the current collector plate's average thickness at the lands. This is done by marking a spot at 5 mm from the edges of the plate at each corner and then measuring the thickness at each mark using a Starett® No. 734 micrometer. The average of the four measurements is then taken as the average thickness of the molded current collector plate at the lands.

3. Measuring the current collector plate's through-plane resistivity using the contact resistance method. The current collector plate is placed between two gold plates at 314 psi. A power supply is used to send a known current through the gold plates and resistance R is calculated using Ohm's Law, i.e., the formula I=V/R, where I is the current in amps and V is the potential drop in mV as read from a multimeter. Through-plate resistivity is calculated using the equation: ρ=R×A/T, where A is the area of the plate and T is the thickness of the plate.

4. Removing the current collector plate's surface layer at the lands by abrasion using a 3M Type “A” Very Fine Scotch-Brite® pad. The plate is rubbed by hand with the pad in a unidirectional manner for approximately 5 seconds on each side and the excess dust is the wiped off.

5. Repeating these steps until the desired plate thickness at the lands is removed.

In the preferred embodiment of the present invention, the current collector plate is molded from a composition as described in co-pending of PCT patent application no. PCT/CA03/00202 filed Feb. 13, 2003. The composition includes from about 10 to about 50% by weight of a plastic, from about 10 to about 70% by weight of a graphite fibre filler having fibres with a length of from about 15 to about 500 micrometers, and from 0 to about 80% by weight of a graphite powder filler having a particle size of from about 20 to about 1500 micrometers. Preferably, the plastic is selected from thermoplastic and thermosetting plastics and elastomers, and most preferably the plastic is a thermoplastically processable polymer. Preferably, the composition comprises:

a. from about 20 wt % to about 30 wt % of ZENITE® 800 aromatic polyester resin;

b. from about 15 wt % to about 25 wt % of pitch-based graphite fiber (fiber length distribution range: 15 to 500 μm; fiber diameter: 8 to 10 μm; bulk density: 0.3 to 0.5 g/cm³; and real density: 2.0-2.2 g/cm³); and

c. from about 40 wt % to about 60 wt % graphite powder (particle size distribution range: 20 to 1500 μm; surface area: 2-3 m²/g; real density: 2.2 g/cm³).

It has been found that the through-plane resistivity of the current collector plate can be sufficiently reduced when only about 5 micrometers of the surface layer is removed. Moreover, the resistivity has been found to drop by approximately 50% by removing less than about 10 micrometers of the molded plate's surface layer.

The following examples illustrate the various advantages of the preferred method of the present invention.

### EXAMPLES

### Example 1

Example 1 shows the reduction in through-plane resistivity of a current collector plate as some of its surface layer is abraded such that the thickness of the plate is gradually reduced.

Two 4″×4″ blank current collector plates were compression molded from a composition of 25% by weight ground ZENITE® 800 resin, 20% by weight graphite fiber and 55% by weight graphite powder. The composition was compounded using a Coperion® Buss kneader, and the compounded composition was then pressed using a Wabash® press to form the conductive current collector plate. The two plates were identified as “A” and “B”.

The thickness of each plate was measured using the method described above, namely at 5 mm from the corners using a Starett® No. 734 micrometer capable of measuring down to 1 μm. A spot was marked at 5 mm from each edge of the plate to ensure that the thickness was measured at the same location each time.

The surface layer removal process was done by hand using a 3M Type “A” Very Fine Scotch-Brite™ pad. Each pass per side required about 5 seconds and each pass was done in a unidirectional manner. The plate was then cleaned by wiping with a tissue paper to eliminate the dust created during each pass. It was found that approximately 1 μm of the surface layer was removed when one pass on each side of the plate was made.

Table 1 shows the average thickness of plate A after each side was passed twice, and also shows the corresponding contact resistivity value and drop percentage.

TABLE 1

| Average | Thickness | Contact | Drop in |
|---|---|---|---|
| Thickeness | Removed | Resistivity | Resistivity |
| (mm) | (mm) | (ohm · cm) | (%) |
| 2.185 | 0.000 | 0.119 | 0.0 |
| 2.183 | 0.002 | 0.077 | 35.7 |
| 2.180 | 0.005 | 0.062 | 48.2 |
| 2.177 | 0.008 | 0.057 | 52.0 |
| 2.175 | 0.010 | 0.054 | 55.1 |

Table 2 shows the average thickness of plate B after each side was passed once, and also shows the corresponding contact resistivity value and drop percentage.

TABLE 2

| Average | Thickness | Contact | Drop in |
|---|---|---|---|
| Thickeness | Removed | Resistivity | Resistivity |
| (mm) | (mm) | (ohm · cm) | (%) |
| 2.174 | 0.000 | 0.0976 | 0.0 |
| 2.172 | 0.002 | 0.0732 | 25.0 |
| 2.171 | 0.003 | 0.0611 | 37.4 |
| 2.170 | 0.004 | 0.0534 | 45.3 |
| 2.168 | 0.006 | 0.0527 | 46.0 |
| 2.167 | 0.007 | 0.0487 | 50.1 |
| 2.165 | 0.009 | 0.0459 | 53.0 |

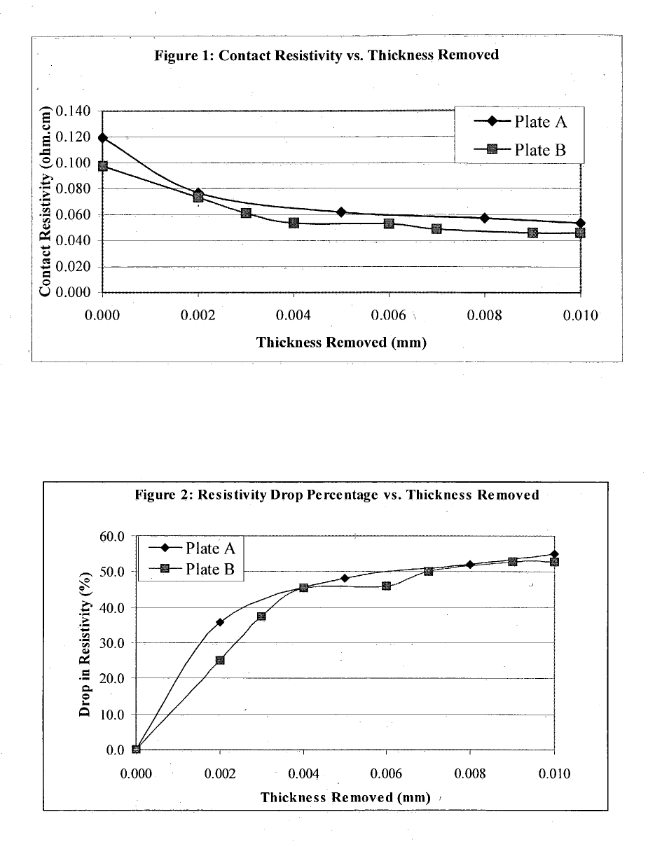

FIG. 1 is a plot that shows the relationship between the contact resistivity values versus the amount of surface layer removed. It is apparent from FIG. 1 that the resistivity drops as the thickness of the plate is reduced. It is also apparent that the slope is steeper in the range of 0.000 to 0.004 mm removed, and then levels off beyond that point.

FIG. 2 is a plot showing the relationship between the percentage drop in contact resistivity versus the amount of surface layer removed. Again, it can be seen that the percentage drop increases steeply until about 0.004 mm of surface layer is removed, and then the change in contact resistivity becomes less significant.

### Example 2

This example shows the reduction in resistivity of a conductive bipolar plate as surface on its “lands” is abraded such that the thickness is reduced. The bipolar plates had flow field channels on both of its sides, and lands located between the channels. No abrasion was done inside the channels. The bipolar plates used were 6.5 inch×4.25 inch in dimension and had serpentine flow fields on both sides.

Again, the thickness at the corners of the molded plates was measured using the Starett® No. 734 micrometer, and the surface layer of the plates was removed as described above.

Similar to Example 1, removal of less than 10 μm of the plate thickness at the lands was achieved and this resulted in a reduction in resistivity of approximately 35% as shown in Table 3.

TABLE 3

| | Average | Thickness | Contact | Drop in |
|---|---|---|---|---|
| | Thickeness | Removed | Resistivity | Resistivity |
| Plate | (mm) | (mm) | (ohm · cm) | (%) |
| C | 2.092 | 0.000 | 0.174 | 0.0 |
| | 2.089 | 0.002 | 0.124 | 28.7 |
| D | 2.088 | 0.000 | 0.209 | 0.0 |
| | 2.079 | 0.009 | 0.137 | 34.4 |

Although the present invention has been shown and described with respect to its preferred embodiments and in the examples, it will be understood by those skilled in the art that other changes, modifications, additions and omissions may be made without departing from the substance and the scope of the present invention as defined by the attached claims.

What is claimed is:

1. A method of making a current collector plate for use in a proton exchange membrane fuel cell, the method comprising the steps of:
(a) molding by injection or compression molding a composition comprising from about 10 to about 50% by weight of a plastic, from about 10 to about 70% by weight of a graphite fibre filler, and from 0 to about 80% by weight of a graphite powder filler to form the current collector plate having two surface layers;
(b) measuring the thickness of the current collector plate; and
(c) removing the surface layers to reduce the thickness of the current collector plate by no more than about 10 micrometers.

2. The method of claim 1, wherein the thickness of the current collector plate is reduced by no more than about 5 micrometers.

3. The method of claim 1, wherein the thickness of the current collector plate is reduced from about 2 to about 4 micrometers.

4. A method of making a current collector plate for use in a proton exchange membrane fuel cell, the method comprising the steps of:
(a) molding by injection or compression molding a composition comprising from about 10 to about 50% by weight of a plastic, from about 10 to about 70% by weight of a graphite fibre filler, and from 0 to about 80% by weight of a graphite powder filler to form the current collector plate having two surface layers, wherein one or both of the surfaces comprise flow field channels and lands defined by the channels;
(b) measuring the thickness of the current collector plate at the lands; and
(c) removing the surface layers at the lands to reduce the thickness of the current collector plate at the lands by no more than about 10 micrometers.

5. The method of claim 4, wherein the thickness of the current collector plate is reduced by no more than about 5 micrometers.

6. The method of claim 4, wherein the thickness of the current collector plate is reduced from about 2 to about 4 micrometers.

7. A method of making a current collector plate for use in a proton exchange membrane fuel cell, the method comprising the steps of:
(a) molding by injection or compression molding a composition comprising from about 10 to about 50% by weight of a plastic, from about 10 to about 70% by weight of a graphite fibre filler, and from 0 to about 80% by weight of a graphite powder filler to form the current collector plate having two surface layers;
(b) measuring the current collector plate's average thickness;
(c) measuring the current collector plate's through-plane resistivity;
(d) removing a portion of the surface layers by abrasion; and
(e) repeating steps (a) to (d) until a desired plate thickness is removed,
wherein the desired plate thickness is no more than about 10 micrometers.

8. The method of claim 4, wherein the desired thickness is no more than about 5 micrometers.

9. The method of claim 4, wherein the desired thickness is reduced by about 2 to about 4 micrometers.

10. A method of making a current collector plate for use in a proton exchange membrane fuel cell, the method comprising the steps of:
(a) molding by injection or compression molding a composition comprising from about 10 to about 50% by weight of a plastic, from about 10 to about 70% by weight of a graphite fibre filler, and from 0 to about 80% by weight of a graphite powder filler to form the current collector plate having two surface layers, wherein one or both of the surfaces comprise flow field channels and lands defined by the channels;
(b) measuring the current collector plate's average thickness at the lands;
(c) measuring the current collector plate's through-plane resistivity;
(d) removing a portion of the surface layers at the lands by abrasion; and
(e) repeating steps (a) to (d) until a desired plate thickness at the lands is removed,
wherein the desired plate thickness is no more than about 10 micrometers.

11. The method of claim 10, wherein the desired thickness is no more than about 5 micrometers.

12. The method of claim 10, wherein the desired thickness is reduced by about 2 to about 4 micrometers.

13. A current collector plate for use in use in a proton exchange membrane fuel cell, wherein the current collector plate has two surfaces and one or both of the surfaces comprise flow field channels and lands defined by the channels, the current collector plate is made by the process steps of:
(a) molding the current collector plate by injection or compression molding from a resin/conductive filler composition;
(b) measuring the current collector plate's average thickness at the lands;
(c) measuring the current collector plate's through-plane resistivity;
(d) removing a portion of the current collector plate's surface layer at the lands by abrasion; and
(e) repeating steps (a) to (d) until a desired plate thickness is removed,
wherein the desired plate thickness is no more than about 10 micrometers.

14. The current collector plate of claim 13, wherein the desired thickness is no more than about 5 micrometers.

15. The current collector plate of claim 13, wherein the desired thickness is reduced by about 2 to about 4 micrometers.

16. A current collector plate for use in use in a proton exchange membrane fuel cell made by the process steps of:
(a) molding the current collector plate by injection or compression molding from a resin/conductive filler composition;
(b) measuring the current collector plate's average thickness;
(c) measuring the current collector plate's through-plane resistivity;
(d) removing a portion of the current collector plate's surface layer by abrasion; and
(e) repeating steps (a) to (d) until a desired plate thickness is removed,
wherein the desired plate thickness is no more than about 10 micrometers.

17. The current collector plate of claim 16, wherein the desired thickness is no more than about 5 micrometers.

18. The current collector plate of claim 16, wherein the desired thickness is reduced by about 2 to about 4 micrometers.
